(19) United States
(12) Patent Application Publication
(10) Pub. No.: US 2011/0172087 A1
(43) Pub. Date: Jul. 14, 2011

(54) METHOD OF FORMING HYDROGEN STORAGE STRUCTURE

(75) Inventors: CHENG-SI TSAO, Taoyuan County (TW); MING-SHENG YU, Taipei City (TW); YI-REN TZENG, Tainan County (TW); HSIU-CHU WU, Pingtung County (TW); TSUI-YUN CHUNG, Taipei City (TW); HUA-WEN CHANG, Hsinchu County (TW); HUAN-HSIUNG TSENG, Miaoli County (TW); CHUN-CHING CHIEN, Taoyuan County (TW); HAW-YEU CHUANG, Taoyuan County (TW)

(73) Assignee: Institute of Nuclear Energy Research Atomic Energy Council, Executive Yuan, Taoyuan County (TW)

(21) Appl. No.: 12/911,057

(22) Filed: Oct. 25, 2010

(30) Foreign Application Priority Data
Jan. 8, 2010 (TW) 099100417

(51) Int. Cl. B01J 21/18

(52) U.S. Cl. 502/185

(57) ABSTRACT

A method of forming a hydrogen storage structure is disclosed, which comprises: providing a porous material formed by micropores and nanochannels, wherein said micropores have a size less than 2 nm and a volumetric ratio larger than 0.2 cm³/g, said nanochannels have a width less than 2.5 nm, and fractal networks formed by said nanochannels have a fractal dimension closed to 3; to form an oxidized porous material by oxidation of said porous material and to properly increase and tailor sizes of said micropores and nanochannels; and forming metal particles of diameters less than 2 nm in said micropores and said nanochannels of said oxidized porous material. By the method according to the present invention, it is capable of constructing a hydrogen storage structure with room-temperature hydrogen storage capability of almost 6 wt %, which satisfies the on-board target criteria of DOE in America by 2010.

### TECHNICAL FIELD

The present disclosure relates to a hydrogen storage technique, and more particularly, to a method of forming hydrogen storage structure with a porous material owning micropores and nanochannels.

### TECHNICAL BACKGROUND

Energy resources are essential for industrialization of a modern nation. After exploitation of petroleum for two centuries, people have been confronting issues of the energy shortage and the environmental climate change (Global Warming) Since the Oil Crisis in 1970s, scientists have endeavored to look for alternative energy to substitute petroleum. Among them, hydrogen, which sources from inexhaustible water, is regarded as one of the promising candidates. Utilizing hydrogen as an energy resource, the final output is only water, and there is no CO₂, the major cause of Global Warming, produced in hydrogen processing. Therefore, hydrogen energy is one of high-efficiency energy resources that meet the requirement of environmental protection, and will become one of main green energy resources in near future.

Hydrogen storage is always one of main challenges in the hydrogen economy. There existed disadvantages in prior arts that hydrogen was stored by high-pressure or liquidizing methods, especially for cost and timing considerations. Hydrogen storage will become more and more popular and important in the fields of future fuel-cell vehicles and portable electronics. The US Department of Energy (DOE) has proposed criteria for hydrogen storage, and some of them are (1) voluminous storage capacity, (2) compact size and light weight, (3) to adsorb and desorb hydrogen in room temperature (RT) and moderate pressure. The on-board target criteria of DOE are 6 wt. % in 2010 and 9 wt. % in 2015; however, there are no materials or structures so far satisfying all those criteria.

Conventional hydrogen storage materials can be classified into two categories: metal hydrides and porous materials. The former adsorbs hydrogen by the chemical bonding, but desorbs hydrogen at several hundred centigrade degrees for voluminous hydrogen adsorption. On the other hand, a porous material adsorbs and desorbs hydrogen by the van der Waals force, but is disadvantageous for its insufficient RT reversible hydrogen storage. The hydrogen storage of the low mass-density carbon materials, such as carbon nanotube, graphite nanofiber, and activated carbon (AC), does not exceed 1 wt %.

With regard to the recent researches on RT hydrogen storage materials, Yang and his co-workers' investigation would be the most promising, wherein hydrogen storage via spillover on the porous carbons doped with metal nanoparticles. The reversible RT hydrogen storage via spillover is different from the conventional physisorption of hydrogen molecules at 77K. In the hydrogen spillover process, the atomic hydrogen is first generated via dissociation of hydrogen molecules on metal nanoparticles, then migrates onto the carbon as the receptor via surface diffusion, and is adsorbed whereon finally. Yang's team has demonstrated the RT hydrogen storage on the porous activated carbons doped with Pt or Pd metal, ranging from 0.6 wt. % up to ˜1.2 wt. %. (Li Y, Yang F H, Yang R T., J. Phys. Chem. C, 111, 3405 (2007); Li Y, Yang R T., J. Phys. Chem. C, 111, 11086, (2007); Li Y, Yang R T, Liu C J, Wang Z., Ind. Eng. Chem. Res. 46, 8277 (2007); Lachawiec A J, Qi G, Yang R T., Langmuir, 21, 11418 (2005); Yang R T, Wang Y., J. Am. Chem. Soc., 131, 4224 (2009)) Moreover, Yang's team added a small amount of Pt-doped activated carbons on the metal-organic frameworks as the secondary spillover receptor, and thus enhanced the reversible RT hydrogen from 0.4 wt. % up to 4 wt. %. (Li Y, Yang R T., J. Am. Chem. Soc., 128, 8136 (2006))

Some relevant documents have mentioned the application of metal catalysts supported carbonbase materials, (US 2007/0082816 A1, Yang R T. Li Y., Qi G., Lachawiec J R. A J. (2007); WO 2005/008813 A1, Kyungwon Enterprise Co. Ltd., Koera Advanced Institute of Science and Technology (2005); US 2003/0108785 A1, L. W, Auburn, Al.(US). (2003); US 005879827 A, Minesota Mining and Manufacyuring Company, St. Paul, Minn. (1999); U.S. Pat. No. 6,482,763 B2, 3M Innovative Properties Company, Saint Paul, Minn. (US). (2002); U.S. Pat. No. 5,928,804 A, The University of Iowa Research Foundation, Iowa City, Iowa (1999)) but those are not concerned with the relation between hydrogen storage by spillover and the condition of metal catalysts in porous structure. In addition, the mechanism of the hydrogen spillover has still been poorly understood. Yang's team believed that the particle size and dispersion of metal on the outer surface of porous material and the connectivity between the metal and the porous material must be the main structural factors to increase the hydrogen storage at RT. (Li Y, Yang F H, Yang R T., J. Phys. Chem. C; 111, 3405 (2007); Li Y, Yang R T., J. Phys. Chem. C, 111, 11086 (2007)) On the other hand, Campesi et al. proposed that the filling of the ordered mesoporous (2-50 nm) carbon template (CT) by 10 wt. % nanocrystalline Pd clusters results in an RT hydrogen uptake (0.08 wt %) eight times higher than that of Pd-free CT (0.01 wt %) and other nanostructured carbon materials. (Campesi R, et al., Carbon, 46, 206 (2008)) However, there are no investigations on the relation between the condition of metal catalysts and the porous structure of carbon template. The present disclosure indicates the size and spatial distribution of metal catalysts impregnated is influenced by the fractal network structure of carbon template, and the hydrogen spillover is affected by small metal catalysts not only on the surface of carbon template but also upon inward walls of the internal pores. The details are described in the embodiments. A homogeneous impregnation of the liquid metal precursor in combination with an appropriate pore structure tuned by oxidation was used to achieve the growth control optimum dispersion of finely pore-confined Pt nanoparticles.

Low mass-density carbon materials, such as carbon nanotube, graphite nanofiber, and activated carbon, are employed as a carbon template to be combined with metal nanoparticles deposited thereon. Consequently, the attainable RT hydrogen uptake on the porous carbons doped with Pt and Pd metal may range from 0.6 wt. % up to ˜1.2 wt. %.

Roughly conclusion, the present disclosure indicates how to derive sufficient capacity of hydrogen storage at room-temperature through an applicable material which is metal catalysts impregnated into the appropriate porous structure of carbon template. And this appropriate pore structure can be tuned by oxidation to accomplish the growth control optimum dispersion of finely pore-confined Pt catalysts.

### TECHNICAL SUMMARY

The present disclosure provides a method for forming a hydrogen storage structure with sufficient capacity of room-temperature hydrogen storage. Firstly a porous material having micropores and nanochannels is provided as a template. Then metal nanoparticles are homogeneously impregnated into the micropores and nanochannels of the template. Finally an effective pore network is built in the template, so that hydrogen atoms produced by the hydrogen spillover mechanism are diffused and adsorbed in the micropores and nanochannels of the template. According to one aspect of this present invention, some criteria for a porous material as a hydrogen template or spillover acceptor are disclosed and provided. Then an acid oxidation treatment is used to increase the pore sizes, so that the metal particles can be homogeneously dispersed into the pore structures of the template. Thus the room-temperature hydrogen storage capacity of a hydrogen storage structure can be improved effectively. Choice of an appropriate starting porous material can be a key factor for optimum synthesis process of hydrogen storage applications.

Compared to Yang's works, the present disclosure demonstrates that using different pore structures followed by both pore tailoring and metal particle impregnation can significantly increase the RT hydrogen uptake by a factor of 6 from 0.6-1.2 wt % to 5.9 wt % at 6.9 MPa.

The present invention provides a method of forming a hydrogen storage structure, comprising the steps of: providing a porous material formed by micropores and nanochannels, wherein said micropores have a size less than 2 nm and a volumetric ratio larger than 0.2 cm³/g, said nanochannels have a width less than 2.5 nm, and fractal networks formed by said nanochannels have a fractal dimension closed to 3; to increase the pore sizes of said porous material by oxidation and form an oxidized porous material; and forming metal particles in said micropores and said nanochannels of said oxidized porous material homogeneously.

Preferably, said porous material is activated carbon, said metal particles are composed of catalyst metal with a size of less than 2 nm.

Preferably, forming metal particles in the oxidized porous material is to dope said oxidized porous material in a solution, comprising: an electrocatalyst precursor composed of said metal element; and a reducing agent to facilitate deposition of said metal particles upon inward walls of said micropores and said nanochannels.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying figures which are given by way of illustration only, and thus are not limitative of the present disclosure and wherein:

FIG. 1 is a schematic flow diagram showing a method for forming a hydrogen storage structure according to an embodiment of the present invention.

FIG. 2 is a schematic hydrogen storage structure according to the present invention.

FIG. 3 is the SAXS profiles of various AC templates according to the SAXS measurement.

FIG. 4 is the X-ray diffraction (XRD) patterns of the four AC templates according to the XRD measurement.

### DETAILED DESCRIPTION OF THE EMBODIMENTS

For further understanding the fulfilled functions and structural characteristics of the disclosure, exemplary embodiments cooperating with detailed description are presented as the follows.

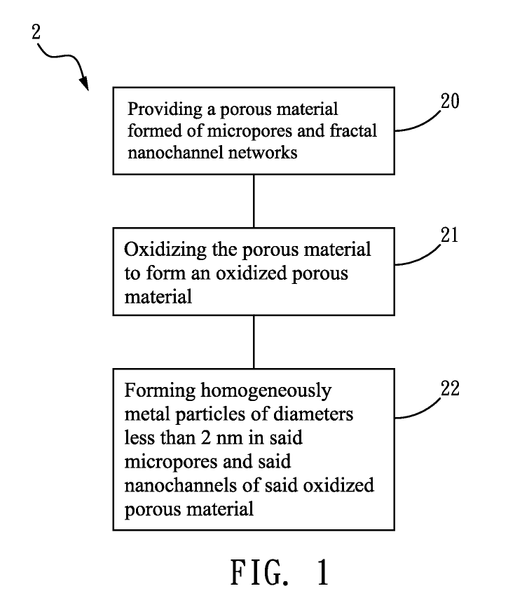

Please refer to FIG. 1, which is a schematic flow diagram showing the method for forming a hydrogen storage structure according to an embodiment of the present disclosure. In the embodiment, the step 20 is to provide a porous material formed by spherical or pillared micropores and fractal nanochannel networks as a template for physisorption of hydrogen molecules and impregnation of nanoparticles. The porous material can be activated carbon (AC) or the like. The volumetric ratio, defined as the ratio of volume of micropores to volume of all pores, is larger than 0.2, and that means the micropores distribute quite densely in the porous material. The micropores have a size less than 2 nm, the nanochannels have a width less than 2.5 nm, and the porous material has a spherical micropore volume larger than 0.25 cm³/g and a fractal nanochannel network of fractal dimension closed to 3.

A step 21 is to oxidize the porous material to form an oxidized porous material. The acid oxidation treatment is used in the embodiment. The porous material is immersed in an acid solution to oxidize the micropores and nanochannels, so that mesopore channels (2-50 nm) are formed in the porous material. The mesopore channels are connected with the nanochannels in the fractal nanochannel network, wherein several spherical micropores are connected by a single nanochannel. The main purpose of the step 21 is to increase and tailor the pore sizes and the nanochannel widths, and to form mesopore channels of larger diameters.

In the step 22, the metal particles with diameters less than 2 nm are confined and formed upon inward walls of the pores in the oxidized porous material. The main purpose of the step 22 is to form metal nanoparticles in the micropores, mesopores, and the connecting nanochannels of the oxidized porous material. The mesopore channels facilitate the subsequent impregnation of metal particles into the micropores. The oxidized porous material is immersed in a solution containing electrocatalyst precursor salts and reducing agents. The electrocatalyst precursor is composed of metal element of the metal nanoparticles, so that the metal nanoparticles can be impregnated into the micropores of the oxidized porous material, wherein the majority of the metal particles are formed upon inward walls of the micropores and nanochannels, and the minority on surface of the porous material. Also in the embodiment, the metal particles are composed of Pt or the like metal catalysts.

After the acid oxidization treatment, the foregoing micropores, mesopores, and nanochannel network structures in the template are expanded to facilitate the Pt nanoparticles to be dispersed into the porous material homogeneously. Although the acid oxidation time is another factor to tailor the pore size of the AC template, the key point of the embodiment is the choice of the starting template structure before metal particle impregnation. In addition, it is noted that the nitrogen sorption isotherm at 77K adopted to characterize pore structure and specific surface area (SSA) has some drawbacks, such as unduly simple model assumptions for pore geometries and the limitation of diffusion hinder. The small-angle X ray scattering (SAXS), which can accurately resolve the geometry features of the pores at different scales and spatial arrangements, is used here to characterize the micropores in the porous material.

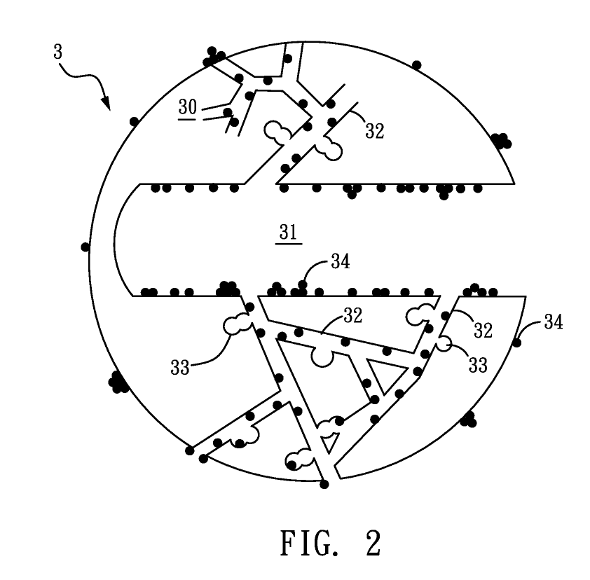

Referring to FIG. 2, a schematic hydrogen storage structure according to the present invention is shown. The structure is also characterized according to the analytical result of the SAXS measurement. The hydrogen storage structure is constructed of a hydrogen-adsorbable porous material 30, which is formed via the step 21. The porous material 30 contains spherical or pillared micropores 33, nanochannels 32 of fractal networks, and at least one mesopore channel 31 connecting the micropores 33 and nanochannels 32. In the embodiment, the micropores 33 have a size less than 2 nm, the nanochannels 32 have a width less than 2.5 nm, and the mesopore channels 31 have a width more than 3 nm. Activated carbon or the like is employed as the porous material in the embodiment.

Metal nanoparticles 34, formed upon inward walls of the nanochannels 32 and micropores 33, dissociate hydrogen molecules into hydrogen atoms. The hydrogen atoms are adsorbed in the nanochannels 32 and micropores 33. In the embodiment, Pt nanoparticles are employed, and the diameter thereof is less than 2 nm The hydrogen storage structure according to the embodiment is highly capable of adsorbing hydrogen molecules at room temperature.

Table 1 shows comparison of pore structural characteristics of various AC templates, determined by the SAXS measurement, wherein AC_CB represents the AC template according to the preferred embodiment of the present invention, AC_CC and AC_GM are two commercial AC templates, and Pt/AC_SC is the AC template provided by the Stream Chemical Company in US. The AC_GM and Pt/AC_SC have nanochannel networks with channel width of 2.14 nm and 1.41 nm, respectively, and almost without spherical networks. The AC_CB consists of spherical micropores of diameter 1.29 nm and fractal networks of channel width 2.08 nm. The AC_CC has micropore diameter of 0.99 nm and nanochannel width of 4.03 nm, but a dense network structure with a fractal dimension of about 3. Among them, the AC_CB meets all criteria for the pore structural characteristics.

TABLE 1
comparison of pore structural characteristics of various
AC templates, determined by the SAXS measurement

| | Spherical | Nanochannel | | Doped Pt |
|---|---|---|---|---|
| | micropore size | width | Fractal | Particle size |
| Sample | (nm) | (nm) | dimension | (nm) |
| AC_CB | 1.29 | 2.08 | 3.0 | 2.00 |
| AC_CC | 0.99 | 4.03 | 3.0 | 2.55 |
| AC_GM | — | 2.14 | 2.9 | 4.48 |
| Pt/AC_SC | — | 1.41 | 3.0 | 8.34 |

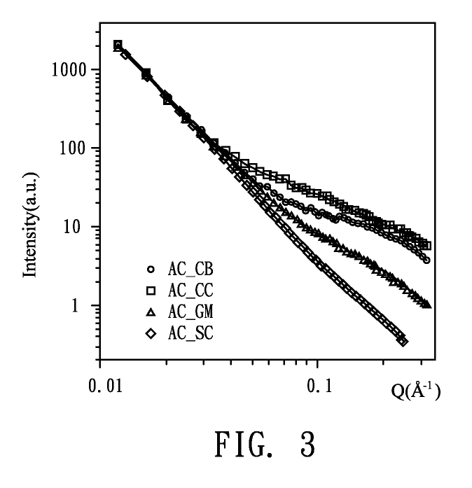

Referring to FIG. 3, the SAXS profiles of various AC templates according to the SAXS measurement are shown. Only the AC_CB shows a feature of Guinier shape in the Q region, 0.1 Å⁻¹<Q<0.3 Å⁻¹, compared to the other samples with intensities still contributed by the fractal network in the same Q region. The Guinier profile stands for that AC_CB has a relatively high fraction of micropores. In contrast, the SAXS profiles of other AC templates show low densities of spherical micropores. According to Table 1, the micropore size and the nanochannel width of AC_CB are not larger than 2.1 nm, causing well-conditioned impregnation of metal nanoparticles. It is noted that these structural features cannot be measured by the conventional gas sorption method, but can be measured by the SAXS method. The porous material, adopted in the embodiment, has micropores of a size less than 2 nm and a volumetric ratio larger than 0.2, nanochannels of a width less than 2.5 nm, and fractal nanochannel networks of a fractal dimension closed to 3.

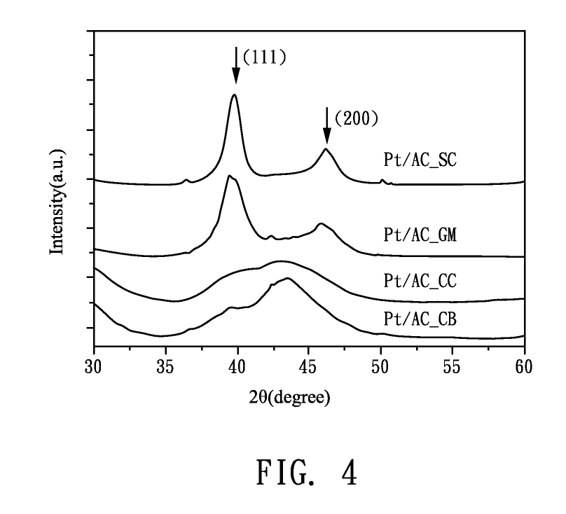

The porous material with the foregoing features is oxidization-treated to form micropores to facilitate appropriate growth condition for the impregnation of metal particles. FIG. 4 shows the X-ray diffraction (XRD) patterns of the four AC templates according to the XRD measurement. The relatively broad diffraction peak Pt(111) of AC_CB and AC_CC overlaps with the peak from carbon, indicating the existence of small Pt particles. The overlapped diffraction peak can be unfolded by the fitting technique. According to the XRD patterns, the calculated metal particle sizes are listed in Table 1. The AC_GM and Pt/AC_SC have hardly any spherical micropores or too narrower channel so that acid oxidation may be difficult to create sufficiently large pores to grow the pore-confined Pt particles. This situation induces the large Pt particles formed on the surface of AC. On the other hand, the wider nanochannel width of the AC_CC and the large micropore size of the AC_CB are helpful for the effective acid oxidation to facilitate growth of fine particles in the porosity (the particle size is less than about 2 nm).

An exemplary embodiment provides a porous material formed of micropores and nanochannels, wherein the micropores have a size less than 2 nm and a volumetric ratio larger than 0.2 cm³/g, the nanochannels have a width less than 2.5 nm, and fractal networks formed of the nanochannels. The porous material is immersed in a solution consisting of HNO₃ and H₂SO₄ at the temperature of 90˜120° C. for an appropriate time period (less than 100 min). The oxidized AC was doped with Pt nanoparticles in a solution containing electrocatalyst precursor salt (H₂PtCl₆.6H₂O), the reducing agents of ethylene glycol (EG) and sodium hydrogen sulfite (NaHSO₃) on a hot plate of 120˜140° C. To increase the dispersion of the Pt ions, an acid salt, such as 1M NaHSO₃, added in the solution to increase ion distribution of said metal. To optimize growth condition of the metal particles, an alkali, such as NaOH, added in the solution to adjust pH value of the solution and, therefore, adjust crystalline growth condition of the metal particles. Also, AC_CB, AC_CC, and AC_GM denote various AC templates as denoted in Table 1. After the acid oxidation and Pt-impregnation treatment, the RT hydrogen uptakes of the Pt/AC samples prepared from the various AC templates are listed in Table 2, measured by the nitrogen sorption analysis.

TABLE 2
the structural characteristics and hydrogen storage of various
AC templates at room temperature, measured
by the nitrogen sorption analysis.

| | | | Micro- | Total | BJH | Average |
|---|---|---|---|---|---|---|
| | H₂ | BET | pore | pore | mesopore | pore |
| | uptake | SSA | volume | volume | diameter | diameter |
| Sample | (wt %) | (m²/g) | (cm³/g) | (cm³/g) | (nm) | (nm) |
| AC_CB | | 1886 | 0.275 | 0.976 | 3.07 | 2.07 |
| Pt/AC_CB | 5.85 | 714 | 0.154 | 0.380 | 4.40 | 2.12 |
| AC_CC | | 2927 | 0.006 | 1.5 | 2.5 | 2.05 |
| Pt/AC_CC | 1.03 | | | | | |
| AC_GM | | 900 | 0.234 | 0.567 | 4.99 | 2.51 |
| Pt/AC_GM | 0.64 | 345 | 0.080 | 0.205 | 4.11 | 2.38 |
| Pt/AC_SC | 1.10 | 1034 | 0.252 | 0.777 | 5.66 | 3.00 |

Referring to Table 2, the porous material according to the present invention, AC_CB, has a spherical micropore volume is 0.275 cm³/g, larger than 0.25 cm³/g. After the acid oxidization and Pt-particle impregnation, the Pt/AC_CB in the exemplary embodiment demonstrates RT hydrogen uptake capacity of about 5.9 wt % at 6.9 MPa, which meets the on-board target criteria of DOE by 2010.

With respect to the above description then, it is to be realized that the optimum parametric relationships for the parts of the disclosure, to include variations in size, materials, shape, form, function and manner of operation, assembly and use, are deemed readily apparent and obvious to one skilled in the art, and all equivalent relationships to those illustrated in the figures and described in the specification are intended to be encompassed by the present disclosure.

What is claimed is:

1. A method of forming a hydrogen storage structure comprising the steps of:
providing a porous material having micropores and nanochannels, wherein said micropores have a size less than 2 nm and a volumetric ratio larger than 0.2 cm³/g, said nanochannels have a width less than 2.5 nm, and fractal networks formed of said nanochannels have a fractal dimension closed to 3;
oxidizing and etching said porous material; and
forming metal particles of diameters less than 2 nm in said porous material to form a hydrogen storage structure.

2. The method of forming a hydrogen storage structure according to claim 1, wherein said porous material is composed of activated carbon.

3. The method of forming a hydrogen storage structure according to claim 1, wherein said metal particle is a catalyst.

4. The method of forming a hydrogen storage structure according to claim 1, wherein said metal particle is composed of Pt.

5. The method of forming a hydrogen storage structure according to claim 1, wherein the majority of said metal particles are formed on said micropores or in said nanochannels, and the minority on surface of said porous material.

6. The method of forming a hydrogen storage structure according to claim 5, wherein said metal particles have a size less than 2 nm.

7. The method of forming a hydrogen storage structure according to claim 1, wherein the step of forming metal particles is to dope into said oxidized porous material in a solution comprising:
an electrocatalyst precursor composed of said metal element; and
a reducing agent to facilitate deposition of said metal particles into said porous material.

8. The method of forming a hydrogen storage structure according to claim 7, wherein said reducing agent comprises ethylene glycol and acid salt.

9. The method of forming a hydrogen storage structure according to claim 7, wherein said electrocatalyst precursor is H₂PtCl₆.6H₂O.

10. The method of forming a hydrogen storage structure according to claim 7, wherein the step of forming metal particles further comprises: adding an acid salt in said solution to increase ion distribution of said metal.

11. The method of forming a hydrogen storage structure according to claim 7, further comprising adding an alkali in said solution to adjust crystalline growth condition of the metal particles.

12. The method of forming a hydrogen storage structure according to claim 1, wherein the step of oxidizing is an acid oxidation treatment.

13. The method of forming a hydrogen storage structure according to claim 1, wherein characteristics of said micropores and said nanochannels in said porous material are measured by the small-angle X-ray scattering method.
